(19) United States
(12) Patent Application Publication
(10) Pub. No.: US 2021/0347154 A1
(43) Pub. Date: Nov. 11, 2021

(54) PEELABLE FILM

(71) Applicant: Bemis Company, Inc., Neenah, WI (US)

(72) Inventors: Jake M. Finkbiner, Appleton, WI (US); Susan L. Montano, Oshkosh, WI (US); Justinian R. Broughton, Appleton, WI (US)

(21) Appl. No.: 17/272,030

(22) PCT Filed: Aug. 31, 2018
(86) PCT No.: PCT/US2018/049019

§ 371 Date: Feb. 26, 2021

(51) Int. Cl. B32B 27/08; B32B 27/30; B32B 27/32; B32B 27/34; B32B 27/36; B32B 37/15; B32B 7/12

(52) U.S. Cl. CPC B32B 27/08; B32B 2377/00; B32B 27/308; B32B 27/32; B32B 27/34; B32B 27/36; B32B 37/153; B32B 7/12; B32B 2250/02; B32B 2250/03; B32B 2250/04; B32B 2250/05; B32B 2250/24; B32B 2307/31; B32B 2307/412; B32B 2307/546; B32B 2307/7244; B32B 2307/7248; B32B 2307/7265; B32B 2307/732; B32B 2307/748; B32B 2439/06; B32B 2439/70; B32B 2439/80; B32B 2323/043; B32B 2323/10; B32B 2329/04; B32B 2333/00; B32B 2367/00; B32B 27/306

(57) ABSTRACT

A first layer that is a peelable film includes a bonding sublayer and a sealing sublayer. The bonding sublayer includes a non-neutralized ethylene acid copolymer, The scaling sublayer includes a first polyethylene and an ethylene acid copolymer or blends thereof. The first layer is adapted to withstand exposure to sterilization processes and the first layer can be essentially free of blistering.

### TECHNICAL FIELD

This disclosure is related to flexible, multilayer packaging film, and in particular, to films that include a composition that provides an easily peelable bond when sealed to itself or another polyolefin material. The films also demonstrates low levels of blistering and little interlayer film destruction when exposed to sterilization conditions that include high heat and/or high pressure.

### BACKGROUND

Many items, including food, pharmaceutical or medical related items, can be packaged in bags or pouches that are formed from flexible packaging film. The flexible packaging film can be a multilayer film to include abuse layers, sealant layers, oxygen or moisture barrier layers, bulk layers, or any such layer that is desired for the particular use of the film. The edges or an area near the edges of the flexible packaging film can be hermetically sealed together to envelop the contents contained therein. The packaging film may include a peelable component, such that when an end user is accessing the contents of the package, the seal may be peeled apart.

There are several processes for the elimination of pathogens and reduction of spoilage organisms for oxygen sensitive items such as food. Pasteurization processes such as aseptic or hot-filling can be used during the packaging process. After packaging, thermal retort processing and high pressure pasteurization (HPP) operations can be utilized. The terms “sterilization” or “sterilization processes”, as used herein, refer to the aforementioned elimination and reduction processes.

These sterilization processes impose severe restrictions on the choice of materials for the packaging film and the seals forming the package. The packaging film and seals must survive temperatures of over 70 degrees Celsius or typical retort conditions of steam or water at 121 degrees Celsius or higher and under pressure for one half hour or more. Retort conditions described herein may be similar to those described in WO18118068A1, filed Dec. 22, 2016, incorporated herein by reference. HPP conditions can include pressures between 300 MPa and 1,000 MPa (43,500 psi to 145,000 psi) at temperatures from below 0 degrees Celsius to above 100 degrees Celsius for a duration of milliseconds to over 20 minutes, as is known in the art.

The problem with current packaging materials include the inability to resist 1) the physical and mechanical abuse imposed by the sealing and/or food packaging processes and 2) the shearing and/or compression forces resulting from the relatively high temperatures and/or pressures during the sterilization processes. For example, the various sterilization conditions can cause delamination of some or all of the layers of a multilayer film. The delamination of the layers can cause bubbles or blisters that affect the appearance of the film, and if the film is transparent, the appearance of the film and of the product contained therein. Further, the delamination may affect the seals of the package such that the package does not remain sealed. In some instances, a peelable film cannot always deliver a package that is easy to peel open while maintaining a hermetic seal. An easy to peel seal typically includes a peel strength of 2,500 grams per inch or less.

### SUMMARY

There is a need for a peelable film that includes a sealant layer composition that 1) can be hermetically sealed and easily peeled open, 2) can withstand sterilization processes, and 3) essentially does not blister.

The present application describes a peelable film. In one embodiment, the film includes a first layer that includes a bonding sublayer that includes a non-neutralized ethylene acid copolymer. The first layer also includes a sealing sublayer that includes a first polyethylene and an ethylene acid copolymer or blends of the ethylene acid copolymer. The first layer can optionally include one or more intervening sublayer(s) that is positioned between the bonding sublayer and the sealing layer. The bonding sublayer, the sealing sublayer, and any optional intervening sublayer(s) are coextruded and the sealing sublayer includes an exposed sealant surface.

In an embodiment, the bonding sublayer and the sealing sublayer are adjacent to each other.

In an embodiment, the sealing sublayer includes a non-neutralized ethylene acid copolymer.

In an embodiment, the sealing sublayer includes a blend of ethylene acid copolymers that includes a neutralized ethylene acid copolymer.

In an embodiment, the first layer may further include a third sublayer that includes a first barrier material where the bonding sublayer is between the sealing sublayer and the third sublayer.

In an embodiment, the third sublayer includes ethylene vinyl alcohol copolymer (EVOH), polyamide, polyester, or polypropylene.

In an embodiment, the non-neutralized ethylene acid copolymer of the bonding sublayer includes ethylene acrylic acid copolymer (EAA), ethylene methacrylic acid copolymer (EMAA), or blends of the aforementioned copolymers.

In an embodiment, the first polyethylene includes a high density polyethylene in an amount from 15 percent to 60 percent by weight of the sealing sublayer.

In an embodiment, total sealing sublayer ethylene acid copolymer content is present in an amount from 40 percent to 85 percent by weight of the sealing sublayer.

In an embodiment, the sealing sublayer comprises from 5 percent to 50 percent of the first layer thickness.

In an embodiment, the first layer is laminated to a second layer.

In an embodiment, the second layer comprises oriented polypropylene, oriented nylon or oriented polyester.

In an embodiment, the first layer and the second layer are transparent.

In an embodiment, where the first layer includes the optional intervening sublayer(s), the total ethylene acid copolymer content of the sealing sublayer and the optional intervening sublayer(s) may be present in an amount from 12 percent to 70 percent by weight of the first layer.

In another embodiment, the first layer that includes the peelable film includes a bonding sublayer that includes a non-neutralized ethylene acid copolymer. The first layer also includes a sealing sublayer that includes a first polyethylene that includes a high density polyethylene in an amount from 15 percent to 60 percent by weight of the sealing sublayer. The sealing sublayer further includes a blend of ethylene acid copolymers. The blend includes a non-neutralized ethylene acid copolymer and a neutralized ethylene acid copolymer. The bonding sublayer and the sealing sublayer are coextruded. The sealing sublayer includes an exposed sealant surface. The sealing sublayer has a total ethylene acid copolymer content in an amount from 40 percent to 85 percent by weight of the sealing sublayer.

In an embodiment, the blend of ethylene acid copolymers of the sealing sublayer includes ethylene acrylic acid copolymer (EAA) or ethylene methacrylic acid copolymer (EMAA), and a copolymer of ethylene and methacrylic acid partially neutralized with zinc or sodium.

In any embodiment, a package may include the first layer as described above. The package includes a hermetic seal. The hermetic seal is maintained and the first layer is essentially free of blistering after a sterilization process. The hermetic seal has a peel strength from 500 grams per inch to 2,500 grams per inch.

### BRIEF DESCRIPTION OF THE DRAWINGS

Other objects and advantages of the present disclosure will become more apparent to those skilled in the art in view of the following description and the accompanying figures.

FIG. 1 illustrates a cross-sectional view of a first embodiment of a first layer that is a peelable film.

FIG. 2 illustrates a cross-sectional view of a second embodiment of a first layer that is a peelable film.

FIG. 3 illustrates a cross-sectional view of a third embodiment of a first layer that is a peelable film.

FIG. 4 illustrates a cross-sectional view of a fourth embodiment that includes a first layer, peelable film laminated to a second layer that is a multilayer film.

FIG. 5 illustrates a perspective view of a package formed from the multilayer film.

FIG. 6A illustrates a perspective view of a package in a sealed condition that includes the multilayer film.

FIG. 68 illustrates a perspective view of the package of FIG. 6A in a partially opened, or partially unsealed, condition.

The figures show some but not all embodiments. The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

A multilayer film that includes a first layer that is a peelable film is described herein. The multilayer film includes a first layer that includes at least a bonding sublayer and a sealing sublayer. The bonding sublayer includes a non-neutralized ethylene acid copolymer. The sealing sublayer includes an ethylene acid copolymer and a first polyethylene. The first layer can be laminated to a second layer forming a multilayered peelable film. Further, a hermetically sealed package can be made when the multilayered peelable film is sealed to itself (exposed sealant surface to exposed sealant surface) or to another polyolefin material.

The term “peelable seal” and like terminology, as used herein, refer to a seal, and especially heat seals, which are engineered to be readily peelable without uncontrolled or random tearing or rupturing the packaging materials which may result in premature destruction of the package and/or inadvertent contamination or spillage of the contents of the package. A peelable seal is one that can be manually peeled apart to open the package at the seal without resort to a knife or other implement to tear or rupture the package. In the present disclosure, the peelable seal must have a seal strength sufficient to prevent failure of the seal during the packaging process and further normal handling and transport of the packaged article. The peelable seal strength must also be low enough to permit manual opening of the seal. A peelable seal may have an average peelable seal strength of less than 2,500 grams for a one inch (25.4 cm) strip or less than 1,500 grams for a one inch strip or about 500 grams to about 1,000 grams for a one inch strip. Seal parameters such as choice of materials and sealing conditions can be used to adjust the peelable seal strength to the desired level for the particular package and application.

The term “heat seal”, as used herein, refers to the union of a surface (or portion thereof) of one film to a surface (or portion thereof) of another film or two different portions of a surface of the same film using heat and pressure. The heat seal is achieved by bringing two surfaces or portion of a surface into contact, or at least close proximity, with one another and then applying sufficient heat and pressure to a predetermined area of the two surfaces to cause the contacting surfaces to become molten and intermix with one another, thereby forming an essentially inseparable fusion bond between the two surfaces in the predetermined area when the heat and pressure are removed therefrom and the area is allowed to cool

The term “layer”, as used herein, refers to a structure of a single polymer-type or a blend of polymers that may be accompanied by additives and that may be continuous or discontinuous. The layer may be a monolayer or may include sublayers.

The term “sublayer” herein refers to a structure of a single polymer-type or blend of polymers that may be accompanied by additives and that may be continuous or discontinuous and that is a subunit of a layer. For example, a layer composed of sublayers may include at least two sublayers.

The terms “hermetic seal” or “hermetically sealed”, as used herein, refer to a seal that is maintained against the flow of air or fluid, in other words, an airtight or liquid proof seal.

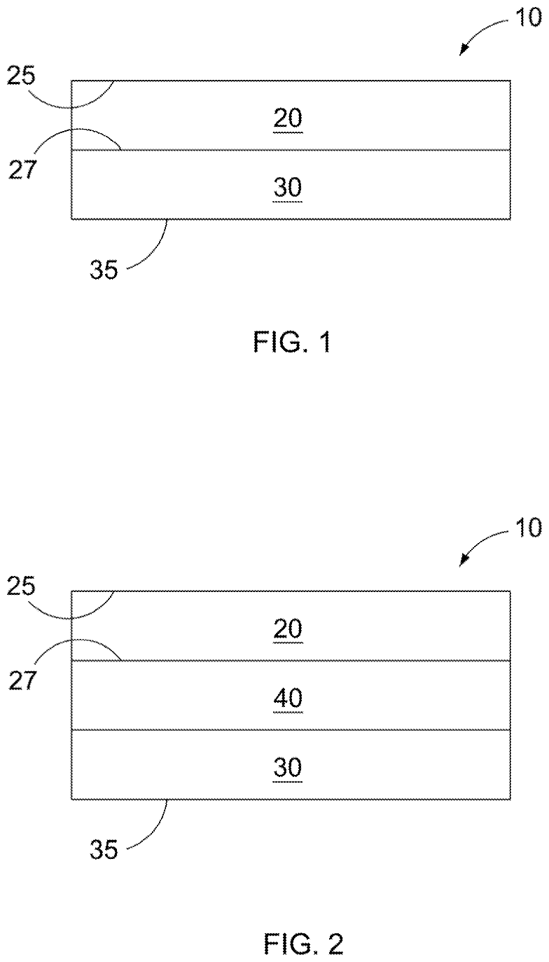

With reference to FIG. 1, a first layer 10 that is a peelable film is shown. The first layer 10 includes a bonding sublayer 20 and a sealing sublayer 30.

Bonding Sublayer

The bonding sublayer 20 includes a non-neutralized ethylene acid copolymer. The term “bonding sublayer” 20, as used herein, refers to a sublayer that, directly or indirectly, bonds the sealing sublayer 30 to the remainder of the first layer 10. The non-neutralized ethylene acid copolymer may include ethylenically unsaturated carboxylic acids and ethylenically unsaturated anhydrides. Ethylenically unsaturated carboxylic acids may be categorized as monobasic or dibasic. Non-limiting examples of monobasic ethylenically unsaturated carboxylic acids include ethylene acrylic acid (EAA), ethylene methacrylic acid (EMAA), ethylene crotonic acid, and may also include corresponding partial esters. Non-limiting examples of dibasic ethylenically unsaturated carboxylic acids include fumaric acid, maleic acid, itaconic acid, and may also include corresponding partial esters. Non-limiting examples of ethylenically unsaturated anhydrides include maleic anhydride, phthalic anhydride, hydrolyzed maleic anhydride, hydrolyzed phthalic anhydride, and may also include corresponding partial esters. Further non-limiting examples of ethylene acid copolymers may include terpolymers formed from the aforementioned ethylenically unsaturated carboxylic acids or anhydrides and ethylene or the following comonomers 1) vinyl acetate, 2) acrylates (methyl, ethyl, n-butyl, ethyl hexyl, etc.), 3) methacrylates, 4) glycidyl methacrylate, or 5) carbon monoxide. The non-neutralized ethylene acid copolymer may include any of the aforementioned copolymers or blends thereof that do not include partially neutralized ethylene acid copolymers. It should be understood that the bonding sublayer 20 can further include processing additives or be blended with other materials, such as, but not limited to, polyolefins, pigments, etc. as is known in the art. The terms “processing aids” or “processing additives”, as used herein, refers to anti-block agents, slip agents, stabilizing agents, release agents, lubricating agents, anti-oxidants, photo-initiators, primers, colorants, and other additives known to and used by a person of ordinary skill in the art without undue experimentation. The use of processing aids varies depending on the equipment, materials, desired aesthetics, etc. The non-neutralized ethylene acid copolymer may be present in the bonding sublayer 20 in an amount from 40 percent to 100 percent, 50 percent to 90 percent, and more specifically, 60 percent to 80 percent by weight of the bonding sublayer 20.

Sealing Sublayer The sealing sublayer 30 functions as a sealant sublayer. The term “sealant sublayer”, as used herein, refers to a sublayer that can form a heat seal with itself or another film, which may be a polyolefin. That is, when the sealant sublayer is exposed to heat, the crystalline structure of the thermoplastic polymer(s) of the sealant sublayer softens, or melts, which allows the thermoplastic polymer(s) to diffuse or intermingle with the thermoplastic polymer(s) that it is being sealed to when pressure is applied. Upon cooling to room temperature, the polymer(s) recrystallizes forming a seal. The sealing sublayer 30 includes an exposed sealant surface 35 that is sealable to itself or another film to form a seal. Further, the seal may be a hermetic seal.

The term “polyolefin”, as used herein, refers to homopolymers or copolymers, including, for example, bipolymers, terpolymers, etc., having a methylene linkage between monomer units which may be formed by any method known to those skill in the art. Suitable examples of polyolefins include polyethylene, low density polyethylene, linear low density polyethylene, very low density polyethylene, ultra-low density polyethylene, medium density polyethylene, high density polyethylene, ethylene/propylene copolymers, polypropylene, propylene/ethylene copolymer, polyisoprene, polybutylene, polybutene, ionomers and the like.

The sealing sublayer 30 includes a blend of a first polyethylene and an ethylene acid copolymer or blends of ethylene acid copolymers. Suitable examples of the first polyethylene may include polyethylene, low density polyethylene, linear low density polyethylene, very low density polyethylene, ultra-low density polyethylene, medium density polyethylene, high density polyethylene. The first polyethylene may be present in an amount from 15 percent to 60 percent, specifically 25 percent to 50 percent, and more specifically 35 percent to 40 percent by weight of the sealing sublayer 30.

The ethylene acid copolymer of the sealing sublayer 30 includes those ethylene acid copolymers that are suitable for use as the non-neutralized ethylene acid copolymer of the bonding sublayer 20. Additionally, the ethylene acid copolymer of the sealing sublayer 30 includes copolymers of monobasic ethylenically unsaturated carboxylic acids with ethylene, such as ethylene acrylic acid (EAA) or ethylene methacrylic acid (EMAA), that are partially neutralized with metal salts, for example, sodium or zinc, that are generally known in the art as ionomers. In an embodiment, the ethylene acid copolymer of the sealing layer 30 may be the same as the non-neutralized ethylene acid copolymer of the bonding layer 20. In another embodiment, the ethylene acid copolymer of the sealing layer 30 may be different than the non-neutralized ethylene acid copolymer of the bonding layer 20.

Further, the sealing sublayer 30 may include a blend of ethylene acid copolymers. For example, the sealing sublayer 30 may include a blend that includes neutralized and non-neutralized ethylene acid copolymers. In another example, the blend may include only neutralized ethylene acid copolymers. In an embodiment, the sealing sublayer 30 may include a blend of EMAA and ionomer. In another embodiment, the sealing sublayer 30 may include a blend of EMAA and of EAA.

The sealing sublayer 30 has a total ethylene acid copolymer content (whether the sealing sublayer 30 includes the ethylene acid copolymer or includes a blend of ethylene acid copolymers) in an amount from 40 percent to 85 percent, specifically 50 percent to 75 percent, and more specifically 60 percent to 65 percent by weight of the sealing sublayer 30. It should be understood that the total ethylene acid copolymer content described herein for the sealing sublayer 30 also includes the ethylene acid copolymer content of any processing aids that are based on ethylene acid copolymers that may also be included in the sealing sublayer 30.

Various, non-limiting embodiments of ethylene acid copolymers that may be included in the sealing sublayer 30, along with possible non-neutralized ethylene acid copolymers that may be included in the bonding sublayer 20, are shown in Table 1. Embodiments that include blends of ethylene acid copolymers in the sealing sublayer include a second ethylene acid copolymer listed in the far right column of the Table 1.

TABLE 1

| | Non-neutralized | Ethylene Acid | Ethylene Acid |
|---|---|---|---|
| | Ethylene Acid | Copolymer | Copolymer |
| | Copolymer | (Sealing | (Sealing |
| Embodiment | (Bonding Sublayer) | Sublayer) | Sublayer) |
| 1 | EAA | EAA | — |
| 2 | EAA | EMAA | — |
| 3 | EAA | EAA | EMAA |
| 4 | EAA | EAA | Ionomer |
| 5 | EAA | Ionomer | EMAA |
| 6 | EMAA | EAA | — |
| 7 | EMAA | EMAA | — |
| 8 | EMAA | EAA | EMAA |
| 9 | EMAA | Ionomer | EAA |
| 10 | EMAA | EMAA | Ionomer |

First Layer

The bonding sublayer 20 and the sealing sublayer 30 may be produced via a coextrusion. The terms “coextruded”, “coextrude”, or “coextrusion”, as used herein, refer to the process of extruding two or more polymer materials through a single die with two or more orifices arranged so that the extrudates merge and weld together into a laminar structure before chilling (i.e., quenching). Examples of coextrusion methods known in the art include, but are not limited to blown film (annular) coextrusion, slot cast coextrusion and extrusion coating. The flat die or slot cast process include extruding polymer streams through a flat or slot die onto a chilled roll and subsequently winding the film onto a core to form a roll of film for further processing.

The term “blown film”, as used herein, refers to a film produced by the blown coextrusion process. In the blown coextrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel and then rapidly cooled or quenched by any of various methods known in the art.

The bonding sublayer 20 and the sealing sublayer 30 may be coextruded such that the bonding sublayer 20 and the sealing sublayer 30 are adjacent to each other as shown in FIG. 1. The terms “adjacent” or “directly adjacent”, as used herein, refer to the lack of an intervening material between the components.

Further, the bonding sublayer 20 and the sealing sublayer 30 may be coextruded such that the bonding sublayer 20 and the sealing sublayer 30 are non-adjacent to each other as shown in FIG. 2. The term “non-adjacent”, as used herein, refers to an intervening material positioned between the components. For example, the first layer 10 shown in FIG. 2 includes an optional intervening sublayer 40 that is between the bonding sublayer 20 and the sealing sublayer 30. It should be understood that the first layer 10 may include any number of optional intervening sublayers 40 between the bonding sublayer 20 and the sealing sublayer 30. The first layer 10 may include one intervening sublayer 40, two intervening sublayers 40, three intervening sublayers 40, four intervening sublayers 40, five intervening sublayers 40, six intervening sublayers 40, seven intervening sublayers 40, eight intervening sublayers 40, nine intervening sublayers 40, ten intervening sublayers 40, and so on.

The optional intervening sublayer(s) 40 can include 1) the first polyethylene and 2) the ethylene acid copolymer or blends thereof. The first polyethylene and the ethylene acid copolymer(s) include those that have been previously described as being suitable for use in the sealing sublayer 30.

In embodiments where the first layer 10 includes at least one optional intervening sublayer 40, the total amount of ethylene acid copolymers that may be present in the sealing sublayer 30 and the at least one optional intervening sublayer(s) 40 may be considered by weight relative to the first layer 10. For example, in an embodiment that includes an ethylene acid copolymer or a blend of ethylene acid copolymers in the sealing sublayer 30 and an ethylene acid copolymer or a blend of ethylene acid copolymers in the intervening sublayer(s) 40, the total ethylene acid copolymer content may be present in an amount from 12 percent to 70 percent, or from 20 percent to 60 percent, or more specifically from 30 percent to 50 percent by weight of the first layer 10.

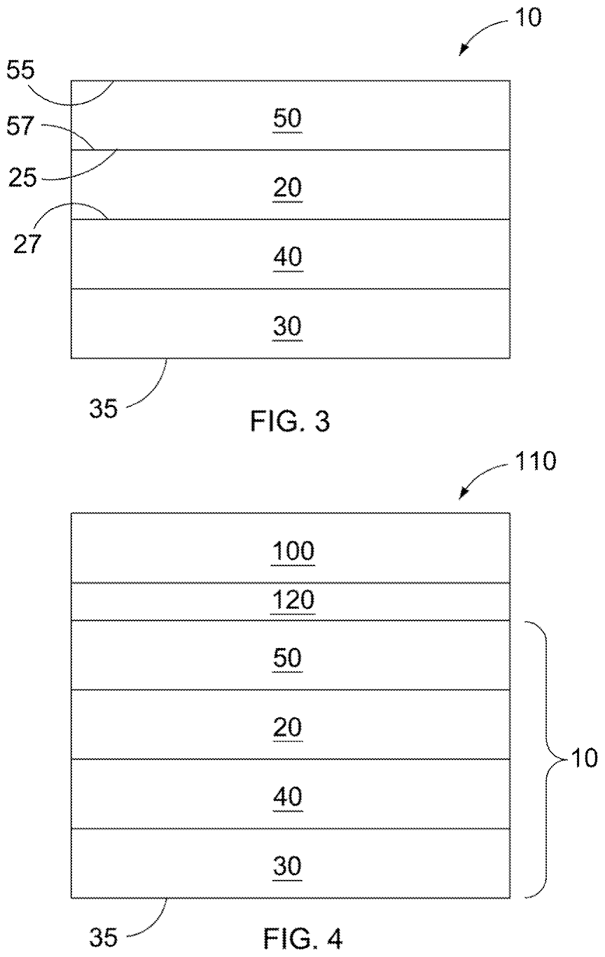

The first layer 10 may include optional sublayers in addition to the bonding sublayer 20, the sealing sublayer 30, and the optional intervening sublayer 40. With reference to FIG. 3, the bonding sublayer 20 includes an exterior surface 25 and an interior surface 27. The term “exterior surface”, as used herein, refers to one of two major surfaces of a sublayer that is oriented away from the sealing sublayer 30. The term “interior surface”, as used herein, refers to one of two major surfaces of a sublayer that is oriented towards the sealing sublayer 30. A third sublayer 50 is shown that includes an exterior surface 55 and an interior surface 57. The interior surface 57 of the third sublayer 50 is adjacent to the exterior surface 25 of the bonding sublayer 20.

The third sublayer 50 may function as a barrier layer. Barrier polymers or barrier materials are generally known to reduce the transmission of a gas or water vapor through the film. Barrier materials may be required for some embodiments where the first layer 10 will be used to package product, such as food, in order to preserve quality of the packaged product through distribution and to extend shelf life. In some instances, a moisture barrier is required to prevent a product from drying out (losing moisture content). In other instances, an oxygen barrier is required to prevent ingress oxygen from degrading a product prematurely. In some embodiments, the third sublayer 50 may be composed of, but not limited to, polyamide, polyamide blends, ethylene vinyl alcohol copolymer (EVOH), polyvinyl chloride, polyvinylidene chloride, glass, thermoplastic polyurethane (TPU), polyethylene terephthalate copolymer (PET), high density polyethylene (HDPE), polypropylene, and may be blends thereof.

The terms “polyamide” or “PA” or“nylon”, as used herein, refer to a homopolymer or copolymer having an amide linkage between monomer units and formed by any method known in the art. Polyamides useful for the third sublayer 50 described herein may be similar to those described in European Patent Specification EP1574328B1, filed Feb. 25, 2005, incorporated herein by reference.

The terms “ethylene vinyl alcohol copolymer” or “EVOH”, as used herein, refer to copolymers comprised of repeating units of ethylene and vinyl alcohol. Ethylene vinyl alcohol copolymers may be represented by the general formula: [(CH₂—CH₂)ₙ—(CH₂—CH(OH))ₘ]. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

The terms “polyester” or “PET”, as used herein, refer to a homopolymer or copolymer having an ester linkage between monomer units. Polyesters may include a homopolymer or copolymer of alkyl-aromatic esters, including but not limited to polyethylene terephthalate (PET), amorphous polyethylene terephthalate (APET), polyethylene furanoate (PEF), glycol-modified polyethylene terephthalate (PETG), and polybutylene terephthalate (PBT); a copolymer of terephthalate and isophthalate including but not limited to polyethylene terephthalate/isophthalate copolymer, such as isophthalic acid (IPA) (modified polyethylene terephthalate (PETI)); a homopolymer or copolymer of aliphatic esters including but not limited to polylactic acid (PLA), polyglycolic acid (PGA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); and blends of any of these materials.

The third sublayer 50 can alternatively be an abuse resistance layer, bulk layer, odor or oxygen scavenging layer, or provide any other desired property for the end-use of the first layer 10. Non-limiting examples of materials include polyethylene, low density polyethylene, linear low density polyethylene, very low density polyethylene, ultra-low density polyethylene, medium density polyethylene, high density polyethylene, ethylene/propylene copolymers, polypropylene, or propylene/ethylene copolymer, ethylene vinyl acetate (EVA), or cyclic olefinic copolymers.

It should be understood that tie layers, as generally known by a person of ordinary skill in the art, may be incorporated into the first layer 10 as appropriate. The terms “tie layer”, “adhesive layer” or “adhesive coating”, as used herein, refer to a material placed on one or more layers or sublayers, partially or entirely, to promote the adhesion of that layer, or sublayer, to another surface. Preferably, adhesive layers or coatings are positioned between 1) two layers of a multilayer film or 2) two sublayers of a layer to maintain the two layers, or sublayers, in position relative to each other and prevent undesirable delamination. Unless otherwise indicated, a tie layer or an adhesive layer or coating can have any suitable composition that provides a desired level of adhesion with the one or more surfaces in contact with the adhesive layer material. Optionally, a tie layer or an adhesive layer or coating placed between two layers or sublayers may include components of each of the layers or sublayers to promote simultaneous adhesion of the adhesive layer to both the layers or sublayers, each on opposite sides of the adhesive layer. In an embodiment, with reference to FIG. 3, the third sublayer 50 may be an oxygen barrier material such as EVOH where a tie layer (not shown) may be positioned between the exterior surface 25 of the bonding sublayer and the interior surface 57 of the third sublayer 50. In another embodiment, the third sublayer 50 may be LLDPE where the interior surface 57 is positioned directly on the exterior surface 25 of the bonding sublayer 20 without the use of a tie layer.

Additional, optional sublayers besides the third sublayer 50 may be coextruded with the first sublayer 20, the second sublayer 30 and the third sublayer 50 when forming the first layer 10. The first additional sublayer may be positioned, for example, on the third sublayer exterior surface 55. Any subsequent additional sublayer may be positioned onto the exterior surface of the adjacent sublayer in a manner similar to how the third sublayer 50 is positioned onto the bonding sublayer 20 as is generally known by one skilled in the art.

The first layer 10 has a thickness that includes the thickness of the bonding sublayer 20, the sealing sublayer 30, any optional intervening sublayer(s) 40, and any optional additional layers, such as the third sublayer 50, or any other additional sublayers or tie layers that may be present. In some embodiments, the first layer 10 may be a layer in a multilayer laminated film. In other embodiments, the first layer 10 may not be laminated or attached to any other layers. In an embodiment, the first layer may be from 5 percent to 100 percent, specifically from 10 percent to 90 percent, more specifically from 20 percent to 70 percent, even more specifically from 30 percent to 60 percent, and further from 40 percent to 50 percent of the film thickness. In an embodiment where the first layer 10 thickness is 100 percent of the film thickness, this indicates that the first layer 10 is not laminated or attached to any other layers. In an embodiment where the first layer 10 thickness is less than 100 percent of the film thickness, this indicates that the first layer 10 is laminated or attached to at least another layer. The first layer 10 thickness can be from 20 microns to 254 microns (0.8 mil to 10.0 mil), from 30 microns to 245 microns, from 40 microns to 235 microns, from 50 microns to 225 microns, from 60 microns to 215 microns, from 70 microns to 205 microns, from 80 microns to 195 microns, from 90 microns to 185 microns, from 100 microns to 175 microns, from 110 microns to 165 microns, from 120 microns to 155 microns, or from 130 microns to 145 microns. For example, in a non-limiting embodiment, the first layer 10 may be included in a forming film and the thickness of the first layer 10 may be from 51 microns to 254 microns (3.0 mil to 10.0 mil). In another non-limiting embodiment, the first layer 10 may be included in a cast film and the thickness of the first layer 10 may be from 25.4 microns to 102 microns (1 mil to 4 mil). Additionally, the first layer 10 may be opaque or transparent.

Further, the thickness of the sealing sublayer 30 and any intervening sublayer(s) may be from 5 percent to 50 percent, specifically from 8 percent to 40 percent, more specifically from 11 percent to 35 percent, and further from 14 percent to 25 percent of the first layer 10 thickness.

Laminated Film

With reference to FIG. 4, the first layer 10 and a second layer 100 may be attached to each other through various laminating methods as known in the art to form a laminated film 110. The term “attached”, as used herein, refers to materials adhering two surfaces to one another, such as the planar surfaces of two film layers. The laminating methods include, but are not limited to, thermal lamination, adhesive lamination, extrusion lamination, and extrusion coating. In an embodiment, the first layer and the second layer 100 may be joined by a laminating agent 120. In an embodiment, the laminating agent 120 may be an extrusion laminating agent 120 where the parameters for such lamination are expected to be set by one skilled in the art without undue experimentation. Further, the laminating agent 120 can be any material and can be added by any known process as long as it does not disrupt the spirit of the disclosure, that is, a first layer 10 that can survive sterilization processes without damage and that can maintain a hermetic seal.

In another embodiment, the laminating agent 120 may be an adhesive laminating agent 120. Unless otherwise specifically indicated, an adhesive may have any suitable composition that provides a desired level of adhesion with the one or more surfaces in contact with the adhesive. Adhesives may be solvent-based, water-based (also known as waterborne), or solventless. Solvent-based adhesives include an adhesive and at least one solvent and requires the solvent to be removed by evaporation (e.g., drying) after the solvent-based adhesive is applied. Non-limiting examples of solvent-based adhesives include polyurethane-based adhesives such as two-part polyurethane adhesives, including but not limited to those with solids content greater than 30 percent by weight. A specific non-limiting example of a solvent based adhesive is a two-part adhesive comprising LIOFOL LA PB5210 (a solvent urethane adhesive) and LIOFOL LA PB 500-83 (a solvent urethane co-reactant), having a solids content of 40 percent by weight available from Henkel Corporation, Rocky Hill, Conn., USA. A further specific non-limiting example of a solvent-based adhesive is a two-part adhesive comprising LAMAL HSA (adhesive) and LAMAL C (co-reactant), having a solids content of 32 percent by weight available from The Dow Chemical Company, Midland, Mich., USA. Another further specific non-limiting example of a solvent-based adhesive is a two-part adhesive comprising ADCOTE 536A (adhesive) and ADCOTE 536B (co-reactant), having a solids content of 40 percent by weight available from The Dow Chemical Company. Another further specific non-limiting example of a solvent-based adhesive is a two-part adhesive comprising ADCOTE 545E (adhesive) and ADCOTE Coreactant CT (co-reactant), having a solids content of 32 percent by weight available from The Dow Chemical Company. A non-limiting example of a laminating adhesive that is a ready-to-use, formaldehyde-free, waterborne adhesive for use in the manufacture of flexible film laminates for food packaging is ROBOND L-90D acrylic adhesive (acrylic-based) available from The Dow Chemical Company. A further non-limiting example of a barrier-type, laminating adhesive is SERFENE 2010 PVdC emulsion available from The Dow Chemical Company. Non-limiting examples of solventless adhesives include various grades of LIOFOL FA 1139 available from Henkel Corporation. In general, the adhesives have negligible effect on the thickness of the film.

With reference to FIG. 4, the first layer 10 that includes the bonding sublayer 20, the sealing sublayer 30, the intervening sublayer 40, and the third sublayer 50 is laminated to the second layer 100 by the laminating agent 120. The second layer 100 may be composed of various materials that may be monolayer or multilayer and that may include sublayers. The second layer 100 may include, but is not limited to plastics, papers, or non-woven materials. In some embodiments, the second layer 100 may be composed of, but not limited to, polyamide, polyamide blends, ethylene vinyl alcohol copolymer (EVOH), polyvinyl chloride, polyvinylidene chloride, glass, thermoplastic polyurethane (TPU), polyethylene terephthalate copolymer, high density polyethylene (HDPE), polypropylene, and may be blends or coextrusions thereof. The second layer 100 may also include metal, such as aluminum foil, metal coated plastic films, aluminum oxide coated films, silicon dioxide coated films, ceramic coated films, or other barrier coatings as is known in the art. Further, the second layer 100 may be opaque or transparent.

In some instances, the second layer 100 may be an oriented plastic film, for example films of oriented polyester, oriented polyamide, oriented polypropylene, or oriented polyethylene. The term “oriented”, as used herein, refers to a film, sheet, web, etc. that has been elongated in at least one of the machine direction or the transverse direction. Such elongation is accomplished by procedures known in the art. Non-limiting examples of such procedures include the single bubble blown film extrusion process and the slot case sheet extrusion process with subsequent stretching, for example, by tentering, to provide orientation. Another example of such procedure is the triple bubble or double bubble process; see, for example, U.S. Pat. Nos. 3,546,044 and 6,511,688, each of which is incorporated in its entirety in this application by this reference. In the triple bubble or double bubble process, an extruded primary tube leaving the tubular extrusion die is cooled, collapsed and then oriented by reheating, reinflating to form a secondary bubble and recooling. Transverse direction orientation may be accomplished by inflation, which radially expands the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film, sheet, web, package, etc. Upon subsequent heating of an unrestrained, unannealed, oriented article to its orientation temperature, heat-shrinkage (as measured in accordance with ASTM Test Method D2732, “Standard Test Method for Unrestrained Linear Thermal Shrinkage of Plastic Film and Sheeting,” which is incorporated in its entirety in this application by this reference) may be induced. Heat-shrinkage may be reduced if the oriented article is first annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line (and in another process) from the orientation process.

In an embodiment, a laminated film 110 may be a first layer 10 and a second layer 100. The first layer 10 includes a bonding sublayer 20 that includes a non-neutralized ethylene acid copolymer. The first layer 10 includes a sealing sublayer 30 that includes a blend of 1) an ethylene acid copolymer that is non-neutralized, 2) an ethylene acid copolymer that is neutralized, and 3) a first polyethylene. In another embodiment, the laminated film 110 includes a second layer 100 that includes an oriented nylon film. The first layer 10 includes a bonding sublayer 20 that includes a non-neutralized ethylene acid copolymer of EMAA. The sealing sublayer 30 includes a blend of an ethylene acid copolymer of EMAA, another ethylene acid copolymer of ionomer and a first polyethylene of HDPE. The first layer 10 and the second layer 100 are laminated with a laminating agent 120 that includes a polyurethane adhesive.

In another embodiment, the laminated film 110 includes a second layer 100 that includes an oriented nylon film. The first layer 10 includes a bonding sublayer 20 that includes a non-neutralized ethylene acid copolymer of EMA. The sealing sublayer 30 includes an ethylene acid copolymer of EMAA and a first polyethylene of HDPE. The first layer 10 and the second layer 100 are laminated with a laminating agent 120 that includes a polyurethane adhesive.

Package

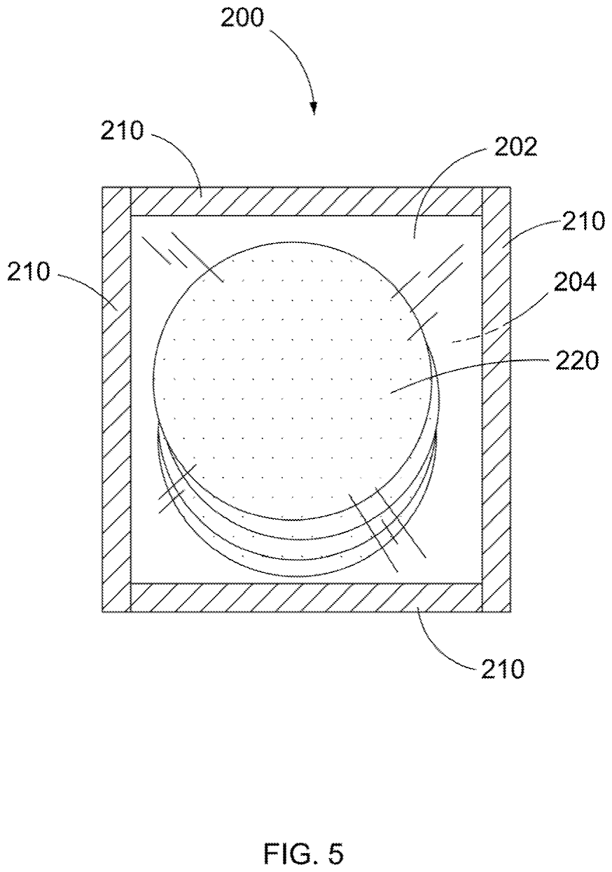

With reference to FIG. 5, the first layer 10 or the laminated film 110 may be fabricated into a package 200. The package 200 may be formed by a form-fill-seal process, a pouching process, or any other flexible packaging process as is generally known in the art. The package 200 that is shown in FIG. 5 includes a first sheet 202 and a second sheet 204. The first sheet 202 and the second sheet 204 are each the first layer 10 or the laminated film 110 sealed to each other near the perimeter of the first sheet 202 and the second sheet 204 to form seals 210. The first layer 10 or the laminated film 110 can be formed into a package 200 that includes hermetic seals 210. The seal 210 may be formed by any known method including heat sealing, ultrasonic sealing, RF welding, etc.

In an embodiment, the first layer 10 or the laminated film 110 may be sealed to itself (exposed sealant surface 35 to exposed sealant surface 35). In another embodiment, the first layer 10 or the laminated film 110 may be sealed to a different film that may have a surface including a polyolefin material. In other embodiments, the first layer 10 or the laminated film 110 may be sealed to other packaging components such as rigid cups, rigid trays, etc., or closures. Non-limiting examples of closures include fitments or interlocking closures such as zippers. The packaging components should be in the spirit of the disclosure such that embodiments including the packaging components are able to withstand sterilization processes.

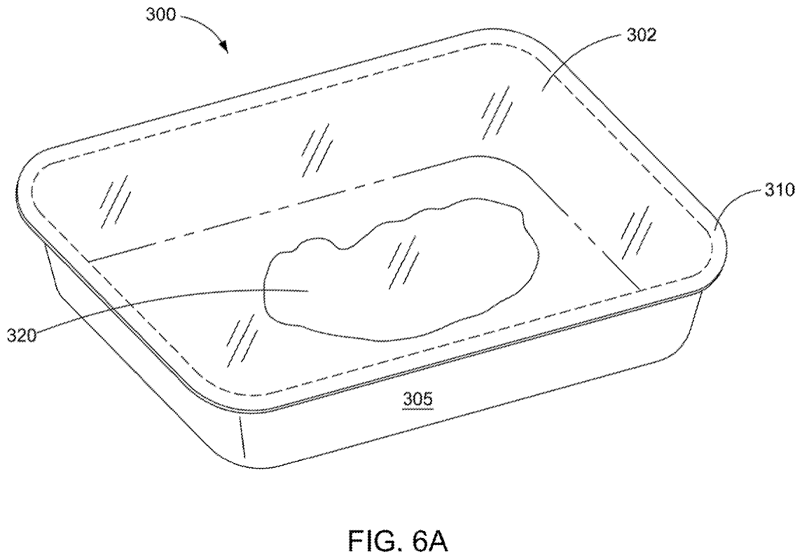

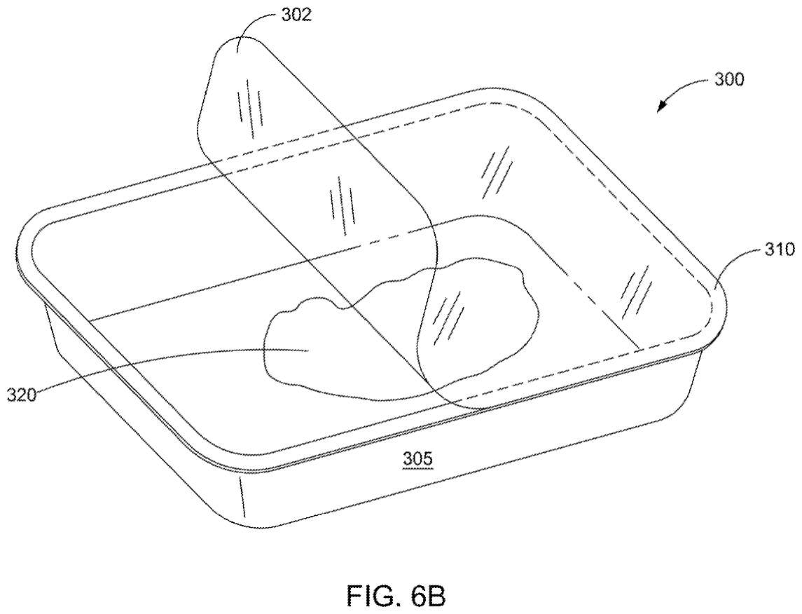

An embodiment of a package 300 that includes a packaging component is illustrated in FIGS. 6A and 6B. The package 300 includes a packaging component that is a rigid tray 305. The package 300 further includes a first sheet 302 that is the first layer 10 or the laminated film 110 that functions as a lid or cover to the tray 305. The first sheet 302 is sealed to the rigid tray 305 with a seal 310 that can be a hermetic seal. FIG. 6B shows the package 300 in a partially opened condition where the first sheet 302 is peeled away or separated from a portion of the tray 305 by opening the seal 310. The first sheet 302 is partially separated from the tray 305 while a portion of the seal 310 remains intact with the tray 305. The separation may be achieved with the application of a peel force within the range of 500 grams per inch to 2,500 grams per inch, even more specifically, 700 gram per inch to 1,300 grams per inch as measured by ASTM F88-15.

The package 200 or 300 can enclose a product 220 or 320 that may be, but is not limited to, any type of consumer or industrial item, medical product, pharmaceutical item, or food item. In some embodiments, the package 200 or 300 may contain the product 220 or 320 and headspace, as is generally known in the art. In other embodiments, the package 200 or 300 may contain the product 220 or 320 without any headspace. In some instances, the package 200 or 300 may be exposed to a sterilization process as previously described. For example, HPP conditions can include: 1) pressures between 300 MPa and 1,000 MPa, specifically 400 MPa to 800 MPa, and more specifically, 500 MPA to 600 MPa, and even more specifically, 550 MPa to 592 MPa, 2) temperatures from below 0 degrees Celsius to above 100 degrees Celsius, specifically 1 degree Celsius to 50 degrees Celsius, and more specifically 4 degrees Celsius to 10 degrees Celsius, and 3) a time period of milliseconds to over 20 minutes, for example, 1 minute, 2 minutes, 3 minutes, 4 minutes, 5 minutes, 6 minutes, 7 minutes, 8 minutes, 9 minutes, 10 minutes, and so on.

After any sterilization processes, the first layer 10 is expected to be essentially free of blistering. The term “essentially free”, as used herein, refers to the referenced film layer that is largely, but not necessarily wholly, absent a particular compound, feature, property, characteristic, etc. The terms “blistering” or “blistered”, as used herein, refer to the delamination of, or within, any of the sublayers (the bonding sublayer 20, the sealing sublayer 30, the optional intervening sublayer 40, the optional third layer 50, or any additional sublayers) that produces a bubbled appearance of the first layer 10. In some embodiments, the first layer 10 is completely free of blistering. In other embodiments, small amounts of blistering may be present. For example, in an embodiment where the package 200 or 300 includes transparent laminated film 110 and contains a product 220 or 320 that is food, a small amount of blistering may be acceptable if the blistering does not affect the barrier properties of the package 200 or 300, and/or 1) the appearance of the package 200 or 300, or 2) the appearance of the food or product 220 or 320 contained therein. In another embodiment where the package 200 or 300 includes a product 220 or 320 that is pharmaceutical in nature, no amount of blistering may be acceptable.

Further, the first layer 10 is able to maintain the package 200 or 300 in a sealed condition while offering a peel strength that allows an end user to easily open the package. Peel strengths that range from 500 grams per inch to 2,500 grams per inch (grams per 25.4 mm) are considered to be easily openable as measured using ASTM F88-15. The sealed condition is referenced with respect to 1) packages 200 or 300 that have endured a sterilization process or 2) packages 200 or 300 that have not endured any sterilization processes. In other words, the first layer 10 may be used in packaging applications that do or do not expose the package 200 or 300 to sterilization.

### Examples

Each of the examples included a structure as generally illustrated in FIG. 4.

A bonding sublayer 20, a sealing sublayer 30, a third sublayer 50 of EVOH, and additional sublayers were coextruded together using a blown film method to form the first layer 10. In some examples, the first layer 10 included an intervening sublayer 40. In all examples, the first layer 10 has a thickness of 50 microns (2.0 mil).

The ethylene acid copolymer that is non-neutralized was present in an amount from 15 percent to 40 percent by weight of the sealing sublayer 30. The first polyethylene of high density polyethylene was present in an amount from 20 percent to percent by weight of the sealing sublayer 30 and the ethylene acid copolymer that is neutralized was present in an amount from 25 percent to 40 percent by weight of the sealing sublayer 30.

The first layer 10 (peelable film) structures may include:

| Example | Structure |
|---|---|
| 1 | Polyethylene/tie layer/EVOH/tie layer/EAA/Ionomer-HDPE- |
| | EMAA/Ionomer-HDPE-EMAA |
| 2 | Polyethylene/tie layer/EVOH/tie layer/EMAA/Ionomer- |
| | HDPE-EMAA/Ionomer-HDPE-EMAA |
| 3 | Polyethylene/tie layer/EVOH/tie layer/Polyethylene/EMA/ |
| | Ionomer-HDPE-EMAA |
| 4 | Polyethylene/tie layer/EVOH/tie layer/EAA/HDPE-EMAA |
| 5 | Polyethylene/tie layer/EVOH/tie layer/EAA/HDPE-EAA/ |
| | HDPE-EMAA |
| 6 | Polyethylene/tie layer/EVOH/tie layer/EAA/Ionomer-HDPE- |
| | EMA/Ionomer-HDPE-EMA |
| 7 | Polyethylene/tie layer/EVOH/tie layer/EMAA/Ionomer- |
| | HDPE-EMA/Ionomer-HDPE-EMA |
| 8 | Polyethylene/tie layer/EVOH/tie layer/Polyethylene/EMA/ |
| | Ionomer-HDPE-EMA |
| 9 | Polyethylene/tie layer/EVOH/tie layer/EAA/HDPE-EMA |
| 10 | Polyethylene/tie layer/EVOH/tie layer/EAA/HDPE-EAA/ |
| | HDPE-EMA |

The first layer 10 was then adhesively laminated to a second layer 100 that was a biaxially oriented polyamide film having a thickness of 15 microns (0.60 mil) to form a laminated film 110. The laminating agent 120 was a solventless polyurethane-based adhesive applied at a weight of 0.8 lb/ream (1.3 g/m²). The first layer 10 and the second layer 110 were transparent, thus the laminated film 110 was transparent.

The laminated film 110 was formed into packages 200 by forming hermetic seals 210 where the exposed sealant surface 35 was sealed to itself. The packages 200 contained product 220 that was sliced deli meat. The packages 200 were then exposed to high pressure pasteurization conditions of 4 degrees Celsius and 550 MPa and 10 degrees Celsius and 592 MPa. Each of the aforementioned temperature and pressure combinations included a 1 minute and 30 second pressurizing period to achieve the given pressure, a 3 minute holding period at the given pressure, and a 1 minute and 30 second depressurizing period to return to atmospheric pressure.

The packages 200 maintained hermetic seals. Visual inspection of the packages 200 indicated that the first layer 10 for each example was free of or essentially free of blistering. The first layer 10 included peel strengths from 500 grams per inch to 2,500 grams per inch or less when tested with ASTM F88-15.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A first layer comprising a peelable film comprising:
a. a bonding sublayer comprising a non-neutralized ethylene acid copolymer, and
b. a sealing sublayer comprising:
i. a first polyethylene;
ii. an ethylene acid copolymer or blends thereof; and
c. optionally, one or more intervening sublayers positioned between the bonding sublayer and the sealing sublayer;
the bonding sublayer, the sealing sublayer, and any optional intervening sublayers are coextruded and wherein the sealing sublayer includes an exposed sealant surface.

2. The first layer of claim 1, wherein the bonding sublayer and the sealing sublayer are positioned adjacent to each other.

3. The first layer according to claim 1, wherein the sealing sublayer comprises a non-neutralized ethylene acid copolymer.

4. The first layer according to claim 1, wherein the sealing sublayer comprises a blend of ethylene acid copolymers that comprises a neutralized ethylene acid copolymer.

5. The first layer according to claim 1, further comprising a third sublayer comprising a first barrier material wherein the bonding sublayer is between the sealing sublayer and the third sublayer.

6. The first layer according to claim 5, wherein the third sublayer comprises ethylene vinyl alcohol copolymer (EVOH), polyamide, polyester, or polypropylene.

7. The first layer according to claim 1, wherein the non-neutralized ethylene acid copolymer of the bonding sublayer comprises ethylene acrylic acid copolymer (EAA), ethylene methacrylic acid copolymer (EMAA), or blends thereof.

8. The first layer according to claim 1, wherein the first polyethylene comprises a high density polyethylene in an amount from 15 percent to 60 percent by weight of the sealing sublayer.

9. The first layer according to claim 1, wherein the total sealing sublayer ethylene acid copolymer content is present in an amount from 40 percent to 85 percent by weight of the sealing sublayer.

10. The first layer according to claim 1, wherein the sealing sublayer comprises from 5 percent to 50 percent of the first layer thickness.

11. The first layer according to claim 1, wherein the first layer is laminated to a second layer.

12. The first layer according claim 11, wherein the second layer comprises oriented polypropylene, oriented nylon or oriented polyester.

13. The first layer according to claim 1, wherein the first layer and the second layer are transparent.

14. The first layer according to claim 1, further comprising the optional intervening sublayer(s) and wherein the total ethylene acid copolymer content of the sealing sublayer and the optional intervening sublayer(s) may be present in an amount from 12 percent to 70 percent by weight of the first layer.

15. A package comprising:
a. at least one sheet comprising the first layer according to claim 1; and
b. at least one hermetic seal;
wherein the hermetic seal is maintained and the first layer is essentially free of blistering after a sterilization process.

16. The package according to claim 15, wherein the hermetic seal comprises a peel strength from 500 grams per inch to 2,500 grams per inch.

17. A first layer comprising a peelable film comprising:
a. a bonding sublayer comprising a non-neutralized ethylene acid copolymer, and
b. a sealing sublayer comprising:
i. a first polyethylene comprising a high density polyethylene in an amount from 15 percent to 60 percent by weight of the sealing sublayer,
ii. a blend of ethylene acid copolymers comprising,
1. a non-neutralized ethylene acid copolymer,
2. a neutralized ethylene acid copolymer;
iii. optionally, one or more intervening sublayers positioned between the bonding sublayer and the sealing sublayer; and
wherein the bonding sublayer and the sealing sublayer are coextruded, wherein the sealing sublayer includes an exposed sealant surface, wherein the sealing sublayer has a total ethylene acid copolymer content from 40 percent to 85 percent by weight of the sealing sublayer.

18. The first layer according to claim 17, wherein the sealing sublayer comprises a blend of ethylene acid copolymers comprising ethylene acrylic acid copolymer (EAA) or ethylene methacrylic acid copolymer (EMAA), and a copolymer of ethylene and methacrylic acid partially neutralized with zinc or sodium.

19. A package comprising:
c. at least one sheet comprising the first layer according to claim 17; and
d. at least one hermetic seal;
wherein the hermetic seal is maintained and the first layer is essentially free of blistering after a sterilization process.

20. The package according to claim 19, wherein the hermetic seal comprises a peel strength from 500 grams per inch to 2,500 grams per inch.
